(19) United States
(12) Patent Application Publication
(10) Pub. No.: US 2023/0225024 A1
(43) Pub. Date: Jul. 13, 2023

(54) ILLUMINATING LEDS

(71) Applicant: Nordic Semiconductor ASA, Trondheim (NO)

(72) Inventors: Øystein SMITH, Trondheim (NO); Frode PEDERSEN, Trondheim (NO)

(73) Assignee: Nordic Semiconductor ASA, Trondheim (NO)

(21) Appl. No.: 18/011,134

(22) PCT Filed: Jun. 18, 2021
(86) PCT No.: PCT/EP2021/066713

§ 371 Date: Dec. 16, 2022

(30) Foreign Application Priority Data
Jun. 19, 2020 (GB) 2009408.2

(51) Int. Cl. H05B 45/10; H05B 45/42; H05B 47/16

(52) U.S. Cl. CPC H05B 45/10; H05B 45/42; H05B 47/16

(57) ABSTRACT

A method of operating a display system consisting of a plurality of light emitting diodes (LEDs) is disclosed. The LEDs are arranged in a plurality of groups and an integrated circuit provides power to the LEDs through a plurality of output pins connected to respective groups. The integrated circuit selectively determines the states of the output pins to illuminate the groups of LEDs in a repeating sequence such that each group is illuminated for a time dependent on a number of groups and a compensation factor. The compensation factor is dependent on at least a number of LEDs in the group.

The present invention relates to a method of illuminating an array of light emitting diodes.

Arrays of light emitting diodes (LEDs) are commonly used to display information. In certain applications, the number of LEDs illuminated may be used to provide information such as an indication of a value. For example the number of illuminated LEDs may indicate the power available from a battery, with the number of LEDs illuminated decreasing as the power available from the battery decreases.

LEDs in an array are typically driven by an integrated circuit which is either a dedicated LED driver circuit or a more general purpose microcontroller. In either case it is often beneficial for the LEDs which need to be illuminated to be grouped so that all the LEDs in a particular group can be illuminated simultaneously. The groups of LEDs may be illuminated consecutively in a repeating sequence at a fast enough rate that all the LEDS in the array appear to the user to be illuminated simultaneously. This reduces the number of output pins required to drive the LEDs.

The Applicant has, however, identified some shortcomings with this approach which it seeks to address with the present invention.

When viewed from a first aspect, the present invention provides a method of operating a display system comprising a plurality of light emitting diodes (LEDs) arranged in a plurality of groups and an integrated circuit providing power to the LEDs through a plurality of output pins connected to respective groups, the method comprising:
the integrated circuit selectively determining the states of the output pins to illuminate the groups of LEDS in a repeating sequence such that each group is illuminated for a time dependent on a number of groups and a compensation factor, wherein the compensation factor is dependent on at least a number of LEDs in the group.

When viewed from a second aspect, the present invention provides a non-transient computer readable storage medium comprising instructions executable by a processor to cause the processor to operate a display system comprising a plurality of light emitting diodes (LEDs) arranged in a plurality of groups and an integrated circuit providing power to the LEDs through a plurality of output pins connected to respective groups, the operation comprising:
selectively determining the states of the output pins to illuminate the groups of LEDS in a repeating sequence such that each group is illuminated for a time dependent on a number of groups and a compensation factor, wherein the compensation factor is dependent on at least a number of LEDs in the group.

When viewed from a third aspect, the present invention provides an electronic device comprising:
a plurality of output pins arranged to connect to a plurality of groups of light emitting diodes (LEDs); and
an integrated circuit arranged to provide power to the LEDs through the plurality of output pins,
wherein the integrated circuit is arranged to selectively determine the states of the output pins to illuminate the groups of LEDs in a repeating sequence such that each group is illuminated for a time dependent on a number of groups and a compensation factor, wherein the compensation factor is dependent on at least a number of LEDs in the group.

When viewed from a fourth aspect, the present invention provides a system comprising:
a display system comprising a plurality of light emitting diodes (LEDs), wherein the LEDs are arranged in a plurality of groups;
a plurality of output pins connected to the plurality of groups of LEDs; and
an integrated circuit arranged to provide power to the LEDs through the plurality of output pins,

wherein the integrated circuit is arranged to selectively determine the states of the output pins to illuminate the groups of LEDs in a repeating sequence such that each group is illuminates for a time dependent on a number of groups and a compensation factor, wherein the compensation factor is dependent on at least a number of LEDs in the group.

Thus it will be seen by those skilled in the art that in accordance with the present invention, whilst the time for which the groups of LEDS are illuminated during a given cycle may be based on dividing the cycle period between the number of groups, it is adjusted based inter alia on the number of LEDs in respective groups e.g. such that all LEDs are perceived by a user to be equally bright. This may improve a user experience. The invention may allow particularly the shortcomings of general purpose microcontrollers to be overcome. General purpose microcontrollers may comprise only a single or a limited number of voltage regulators which are used to regulate the voltage provided to a group of LEDs. Such general purpose microcontrollers may not be able to deliver a consistent voltage to all LED groups as the amount of current drawn increases when there is a larger numbers of LEDs in a group being driven, leading to variations in the brightness of LEDs in the display system. Adjusting the time for which each group is illuminated—i.e. the duty cycle of each group within the sequence—compensates for the variations in the voltage delivered to different groups so that, as mentioned above, a consistent average brightness can be achieved across the groups.

A group of LEDs may comprise any number of LEDs, with typically groups of LEDs comprising different numbers of LEDs. Each group of LEDs may comprise a different number of LEDs. A group comprising a larger number of LEDs will draw a larger current from the integrated circuit. A general purpose microcontroller within the integrated circuit may be unable to deliver the full design voltage to a group comprising a larger number of LEDs as it can to a smaller number of LEDs. Therefore, a group comprising a larger number of LEDs is delivered a smaller voltage from the integrated circuit and therefore appears dimmer than the group comprising a smaller number of LEDs.

Whilst a consistent voltage could be delivered from the integrated circuit by using an integrated circuit with a larger number of or dedicated voltage regulators. e.g. an LED driver chip, it may not be practical in many applications to use such a dedicated driver chip. However in accordance with the present invention, a general purpose microcontroller can be used because the shortcomings of such a device for this purpose may be overcome—because the duty cycle for each group may be dependent on the number of LEDs in the group. Illuminating a group comprising a larger number of LEDs for a longer period of time will result in the LEDs appearing brighter, compensating for any lower voltage delivered to this group.

In a set of embodiments, the output pins are general purpose input/output (GPIO) pins. In a set of embodiments, the output pins may occupy three different states: high; low; off, wherein ‘high’ is a high voltage, ‘low’ is a low voltage and ‘off’ is a high impedance (Z) state, whereby reverse current flow into the pin is prevented. The voltage drop across a high state output pin and low state output pin would typically correspond to the voltage required to drive an LED.

In a set of embodiments the states of the output pins are determined such that each group of LEDs is illuminated individually. Therefore, at any point in the repeating sequence of illumination of the groups, only one group of LEDs is illuminated. In a set of embodiments, a group of LEDs is connected to a high output pin and a low output pin.

In a set of embodiments the LEDs in each group are arranged electrically in parallel.

The LEDs within a group may be physically arranged in any suitable and desirable manner. In a set of embodiments the LEDs within a group are arranged in a line. Whilst different groups may have different arrangements of LEDs, preferably the LEDs have an identical arrangements in all the groups.

The groups of LEDs may be physically arranged with respect to one another in any suitable and desirable manner. In a set of embodiments, the groups are parallel to one another. Where the LEDs within each of the groups are arranged in lines, arranging the groups in parallel may help to provide a uniform arrangement of the groups of LEDs which may improve the appearance of uniform luminosity across the display system. In a set of embodiments, a separation between the groups of LEDs is constant. This may further improve the uniformity of the illumination of the display system.

In a set of embodiments, the LEDs are electrically paired in anti-parallel. Such paired LEDs may be connected to the same output pins but can be illuminated separately. Therefore, in a set of embodiments, the paired LEDS have opposite terminals connected to the same output pin i.e. the anode of a first LED of the pair and the cathode of the second LED of the pair are connected to the same output pin. In such embodiments, when the state of the connected output pins is switched between high and low, a previously unilluminated LED of the pair is illuminated and a previously illuminated LED of the pair becomes unilluminated.

In certain applications, it may be desirable for the LEDs in the display to be arranged to form a square. In such an arrangement, pairs of LEDs may be arranged in mirrored positions on opposing sides of a diagonal of the square.

In a set of embodiments, the states of the output pins are changed such that adjacent groups of LEDs are illuminated consecutively. For example, in an embodiment in which the groups of LEDs form parallel lines of LEDs, the first (e.g. upper most) group is illuminated first, followed by the second (e.g. second upper most) group and this is continued until the last (e.g. lowest) group of LEDs is illuminated. Once all the groups of LEDs have been illuminated, the sequence of illumination of groups restarts from the initially illuminated group and is repeated indefinitely. The time taken to illuminate all the groups of LEDs is referred to as the total cycle.

According to the invention, the compensation factor accounts for the number of LEDs in a group. In a set of embodiments, the compensation factor depends on an empirically determined performance curve of the output pins. The performance curve accounts for the variations in voltage and current delivered by the output pins for groups comprising various numbers of LEDs. Preferably, the integrated circuit comprises a memory arranged to store compensation factor values for each of the different number of LEDs in a group which are supported. The compensation factor values for each of the plurality of groups may then be retrieved from the memory. In such embodiments, the compensation factor is determined during design or testing as opposed to being determined in real time.

The compensation factor may be determined empirically for storage in the memory by measuring a voltage drop across one or more LEDs in the group. This could be an absolute value or may be determined in a relative sense by comparing the voltage drop across two groups comprising different numbers of LEDs. In one example, the compensation factor for a group containing a plurality of LEDs is determined by comparing the voltage drop across the group with another group—e.g. the group in the display system comprising the smallest number of LEDs (e.g. the group containing only one LED). For the compensation factor to provide a compensation such that all LEDs appear of a uniform brightness, the compensation for each group should also take into account the relationship between applied voltage and brightness, which may correspond to a relationship between applied voltage and current passed by the LED.

In general it will be desirable to illuminate only a subset of the LEDs in a physical group at a given time. For example, this may allow various patterns to be displayed on a display system to convey information. In a set of embodiments therefore, at least one of said plurality of groups comprises a virtual group of LEDs which is a subset of a physical group of LEDs and the virtual group of LEDs is illuminated whilst a remainder of the physical group of LEDs remain unilluminated. In such embodiments, the compensation factor may be selected (e.g. by the integrated circuit) based on a number of LEDs in the virtual group. The virtual group is therefore considered to be the group for selection of the compensation factor, e.g. from the values stored in the memory.

Some embodiments of the present invention will now be described, by way of example only, and with reference to the accompanying drawings, in which:

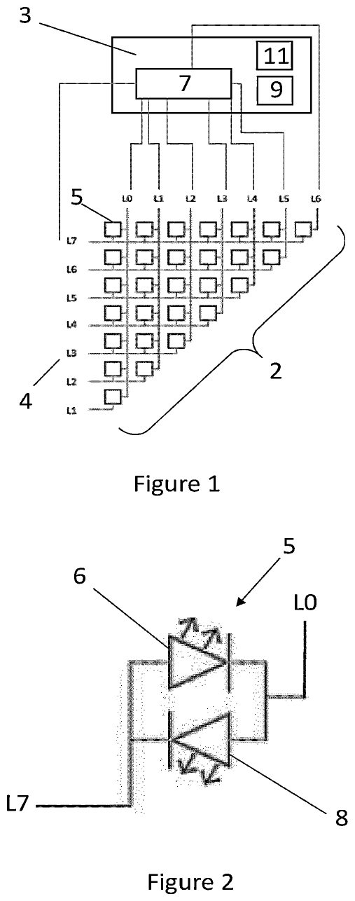

FIG. 1 shows a schematic diagram of a display system in accordance with an embodiment of the invention;

FIG. 2 shows a schematic diagram of the arrangement of a pair of LEDs implemented in the arrangement shown in FIG. 1;

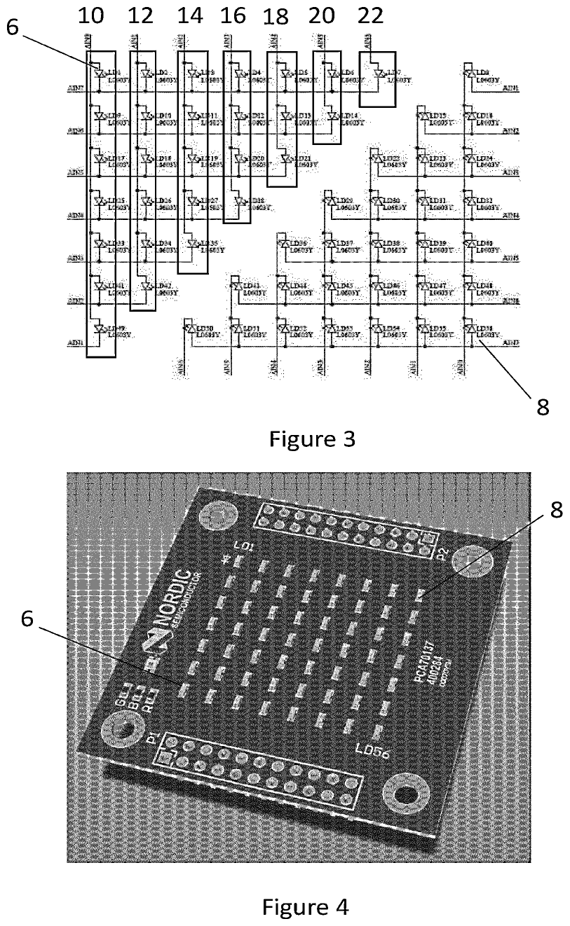

FIG. 3 shows in more detail electrical arrangement of LEDs and output pins in the embodiment of FIG. 1;

FIG. 4 shows the appearance of the exemplary display system;

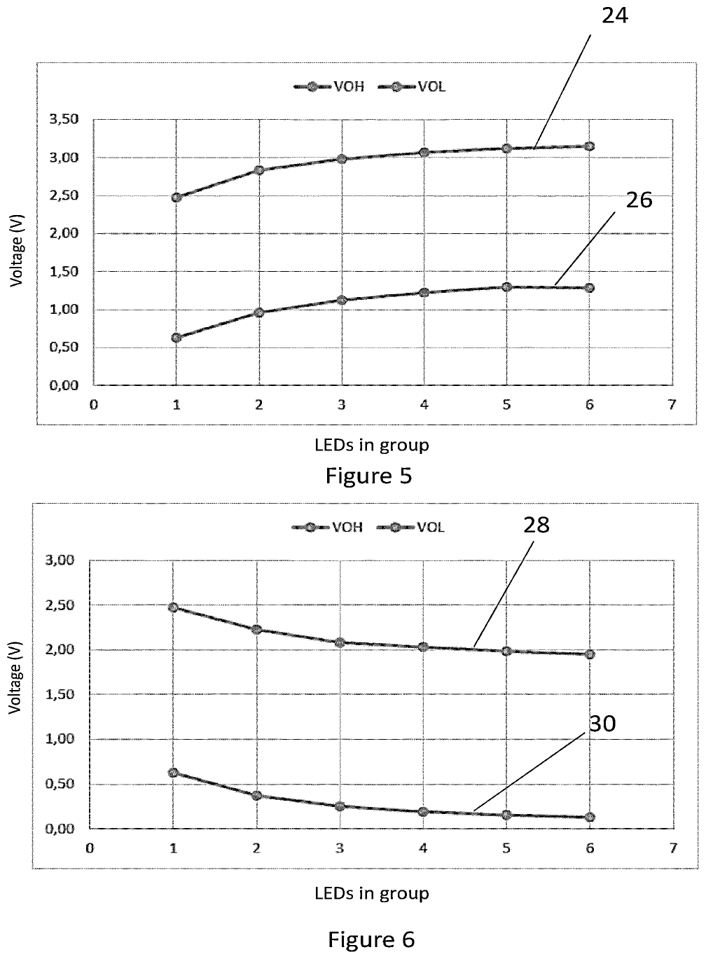

FIGS. 5-6 are graphs of average voltage measured at the high state output pin and at the low state output pin;

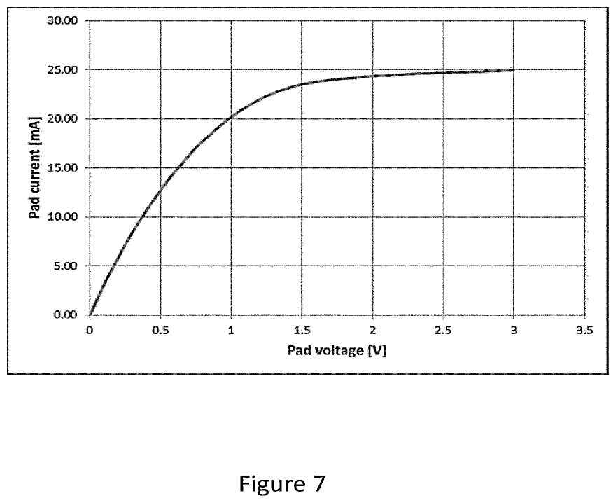

FIG. 7 is a graph of voltage against current for a typical embodiment;

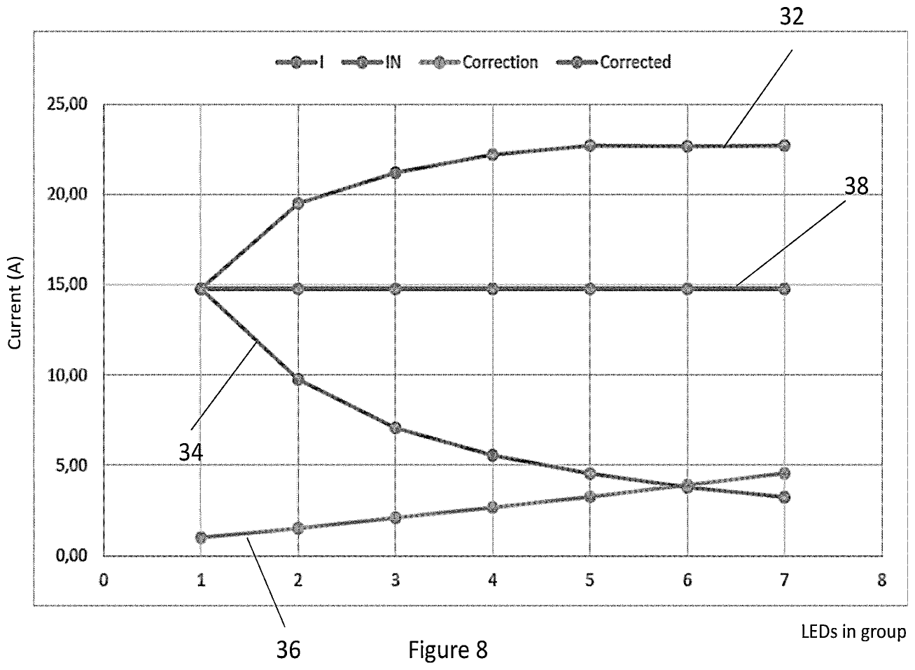

FIG. 8 is a graph of current against the number of LEDs in a group;

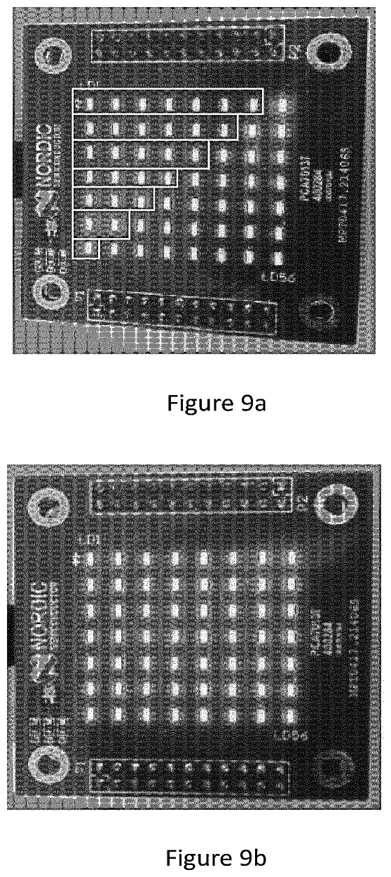

FIG. 9a is an example of an illumination of the display system of FIG. 4 when no compensation is applied;

FIG. 9b is an example of an illumination of the display system of FIG. 4 when a compensation factor is applied;

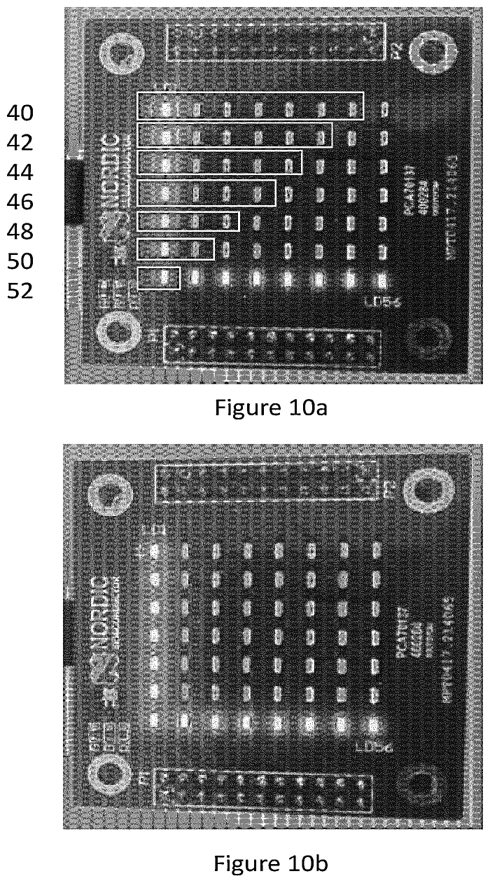

FIG. 10a is an example of an illumination of the display system when no compensation is made for only a subset of a group being illuminated; and

FIG. 10b is an example of an illumination of the display system when a compensation is made for only a subset of a group being illuminated.

FIG. 1 is a schematic diagram showing a display system including an arrangement of a plurality of LED pairs 2. The arrangement also comprises an integrated circuit in the form of a general purpose microcontroller 3 comprising a plurality of output pins L0-L7 which are connected via wires to the plurality of LED pairs. As is shown in more detail in FIG. 3, each LED pair is connected to two output pins L0-L7. For example, the LED pair 5 in the top left corner is connected to pins L7 and L0.

A voltage is applied across the pins by configuring one of the pins in a high state and the other pin in a low state. Within the plurality of pins, it is possible to have multiple pins in a high state and multiple pins in a low state at any given time. Different combinations of states pins L0-L7 will result in different LEDs being illuminated.

The integrated circuit 3 includes a voltage regulator 7 which supplies a voltage to the LEDs via the output pins L0-L7. The voltage regulator 7 supplies all the LEDs in the display system. The integrated circuit 3 also includes a memory 9 and a processor 11.

FIG. 2 shows in more details the LED pair 5 as seen in FIG. 1. The LED pair 5 includes a first LED 6 and a second LED 8. Both the first LED 6 and the second LED 8 are connected to pins L7 and L0 in anti-parallel. This arrangement results in only one of the pair being illuminated at any given time. For example, when L7 is configured in a high state and L0 is configured in a low state, the first LED 8 is illuminated and the second LED 8 is unilluminated. When L7 is configured in a low state and L0 is configured in a high level, the first LED 6 is unilluminated and the second LED 8 is illuminated.

FIG. 3 shows more details of the electrical arrangement of LEDs as seen in FIGS. 1 and 2. In FIG. 3, the paired LEDs are shown physically separated. For example, in LED pair 5 the first LED 6 is located in the upper left corner of the LED arrangement and the second LED 8 is located in the lower right corner of the LED arrangement. Paired LEDs are located in inverted positions with respect to the diagonal.

A set of groups of LEDs 10, 12, 14, 16, 18, 20, 22 can also be seen in FIG. 3. In the embodiments shown in FIG. 3 each of the groups 10, 12, 14, 16, 18, 20, 22 contains a different number of LEDs. The LEDs in each group 10, 12, 14, 18, 18, 20, 22 are arranged in a line. The groups 10, 12, 14, 16, 18, 20, 22 form a triangle composed of sets of parallel lines.

An opposing set of groups of LEDs is formed from the corresponding paired LEDs. These LEDs form a second triangle. Both sets of groups are arranged with respect to each other so as to form a square. FIG. 4 is an example of a display system incorporating the arrangement shown in FIG. 3.

Operation of the display system will now be described. To illuminate each of the groups sequentially, the output pins are drive to different states. With reference to FIG. 1, to illuminate a first group of LEDs (i.e. the top row of LEDs seen in FIG. 1), output pin L7 is driven to a low state and output pins L6-L0 are driven to a high state. With reference to FIG. 2, this causes the lowermost LED 8 of the top left/bottom right corner pair 5 (see FIG. 3) to be illuminated and similarly for the rest of the pairs in the top row. To illuminate a second group of LEDs (i.e. the second row of LEDs seen in FIG. 1), output pin L6 is driven to a low state, output pins L5-L0 are driven to a high state and output pin L7 is drive to an off (high impedance) state. The remainder of the groups of LEDs are illuminated similarly, with the final single LED at the bottom of the pattern seen in FIG. 1) being illuminated by driving output pin L1 to a low state, output pin L0 to a high state and output pins L7-L2 to an off state.

The sequence then continues by illuminating the other member of each anti-parallel pair. With reference to FIG. 2, it will be seen that in the case of the corner pair 5, by driving L7 high and L0 low, the uppermost LED 6 is illuminated and similarly for the other pairs in the top row. As before the sequence continues to the second row but with L6 high and L5-L0 low and so on until L1 is high and L0 is low to illuminate the single LED in the top right (see FIG. 3)

The sequence of illuminating all the groups of LEDs described above is repeated in a cycle. The processor 11 controls the sequence of illuminations in the cycle by changing the states of the output pins L7-L0 as described above. The cycle may be suitably short, with each group of LEDs only illuminated for a short time, such that all the groups appear to be illuminated simultaneously. The cycle may, for example, be repeated more than thirty times a second.

What the Applicant has realised is that if each group of LEDs is illuminated for the same period of time within the cycle, e.g. all groups of LEDs have the same duty cycle, the display system appears non-uniform in brightness, as groups comprising a smaller number of LEDs appear brighter because the voltage regulator 7 is able to provide a voltage close to the nominal value as less overall current is draw. Conversely when more LEDs are illuminated, the extra current drain causes the voltage supplied to dip. The effect of this is seen in FIG. 9a and explained in detail below. To compensate for this, in accordance with the invention the duty cycle of each group is adjusted such that groups comprising a larger number of LEDs have a greater duty cycle than groups containing smaller numbers of LEDs. The calculation of the compensation factor is described in more detail below with reference to FIGS. 5-8 and Equations 1-4.

FIGS. 5 and 6 are graphs of the measured voltage against the number of LEDs in a group for an arrangement as shown in FIG. 3. Both Figures contain a plots corresponding to the voltage at a high state pin (also known as the sourcing pin) 24, 28 and a plot corresponding to the voltage at a low state pin 26, 30 (also known as the sinking pin). In FIG. 5, multiple pins are driven high (multiple source) and only a single pin is driven low (single sink). In FIG. 8, multiple pins are driven low (multiple sink) and only a single pin is driven high (single source). When multiple pins are in the same state, the voltage of each of these pins is averaged.

From FIG. 5 it can be seen that when more LEDs are sinked to a single pin, a higher voltage is measured at the high state pin and at the low state pin as the number of source pins (i.e. high state pins) is increased. From FIG. 6 it can be seen that when more LEDs are sourced from a single pin, a lower voltage is measured at the high state pin and the low state pin. However, the voltage across each LED is constant in both FIGS. 5 and 6.

For a typical LED the relationship between current and voltage is not linear, as shown in FIG. 7. The data shown in FIG. 7 is determined empirically. FIG. 7 may be used to determine the current through a group of LEDs based on the voltage at the high state pin(s) and the low state pin(s). The current through any individual LED within a group can then be determined by dividing the current through the whole group by the number of LEDs in the group.

This relationship is shown in Equation 1:

$${I}_{N} = \frac{f}{N} = \frac{f ( {V}_{OL} ( N ) )}{N} \qquad ( 1 )$$

Where I is the current through a group, N is the number of LEDs in a group, I_{N} is the current through a single LED in a group and f(V_{OL}(N)) is the function shown in FIG. 7.

FIG. 8 shows graphically the relationship between current through a group of LEDs 32 and current through a single LED within the group for various numbers of LEDs 34. The current through a single LED decreases as the number of LEDs in a group increases. This means that LEDs in a group with a large number of LEDs appear dimmer than the LEDs in a group with a smaller number of LEDs. This effect can be seen in FIG. 9a, which shows the variation in brightness of LEDs across a display system. For example, the LED in the lower right corner of the array and the LED is the upper left corner of the array appear brightest as there is only one LED in the group these LEDs belong to.

In order for all the LEDs in each group to appear to have a uniform brightness, a compensation factor is applied in accordance with the invention. The duty cycle for a particular group is defined as the fraction of the total time taken for a cycle of illuminating for which the group is illuminated. The duty cycle D_{N} for a groups of LED is defined by Equation 2:

$${D}_{N} = \frac{{t}_{N}}{T} \qquad ( 2 )$$

Where N is the number of LEDs in a group, t_{N} is the time period over which the LEDs in a group are illuminated and T is the total time taken for a cycle of illuminating all the groups individually. For all the groups to be have an equal brightness regardless of the number of LEDs in a group, the product of the duty cycle for any group and the current through the group must be equal for all groups. This required relationship is expressed in Equation 3.

D_{N}I_{N}=D₁I₁ (3)

Therefore, as the current through an LED in a group varies depending on the number of LEDs in the group, varying the duty cycle depending on the number of LEDs in a group enables the all LEDs appear equally bright. Combining Equations 1, 2 and 3, and re-arranging provides an equation for t_{N} as seen in Equation 4:

$${t}_{N} = {t}_{1} N \frac{f ( {V}_{OL} ( 1 ) )}{f ( {V}_{OL} ( N ) )} \qquad ( 4 )$$

Where f(V_{OL}(N)) and f(V_{OL}(1)) are determined from FIG. 7. The compensation factor is therefore defined as

$$\frac{f ( {V}_{OL} ( 1 ) )}{f ( {V}_{OL} ( N ) )} .$$

Whilst the selected value of t₁ can be chosen to suit the particular application, for embodiments in which it is desirable for all groups of LEDs to be able to appear to be illuminated simultaneously, t₁ should be selected to be suitably short such that the total duration of the cycle T is short enough to benefit from human persistence of vision (e.g. a refresh rate of at least thirty times per second).

Each group of LEDs is then individually illuminated for a period of time equal to t_{N} as calculated using the above equations until all the groups have been illuminated.

This pattern of illumination is then repeated such that all the LEDs appear to be illuminated simultaneously.

FIG. 8 also shows the plot of the duty cycle of a group as a function of the number of LEDs 36 in a group. As can be seen from FIG. 8, the required duty cycle increases as the number of LEDs in a group increases. FIG. 8 further includes a plot of the product of the duty cycle and the current through each LED in a group (D_{N}I_{N}) 38. As can be seen from FIG. 8, this product is constant regardless of the number of LEDs in a group. Therefore, when the duty cycle calculated using the method above is implemented, all the LEDs appear equally luminous.

The resulting appearance of the display system implementing the aforementioned duty cycles is seen FIG. 9b. In contract to the display system seen in FIG. 9a, all the LEDs within the display system appear to be equally bright.

Typically it will be desirable to illuminate only a subset of LEDs in a group in order to form a pattern on the display system. This is shown in FIG. 10a, where the aforementioned duty cycle (calculated assuming all LEDs would be illuminated) is implemented but only one LED is illuminated in each of the groups. The LEDs in groups 40-52 become progressively dimmer ascending through the groups as the duty cycle applied is disproportionate as only one LED is illuminated in each group.

In order to implement the correct duty cycle, each group is considered to comprise only the subset of LEDs illuminated. This subset of the physical group is a virtual group. The virtual groups forming a subset of groups 40-50 comprise one LED. The duty cycles required for all virtual groups to appear equally luminous is then calculated by selecting a compensation factor according to the number of LEDs in the virtual groups. In the particular arrangement shown in FIG. 10a this allows for the duty cycle of the groups where more than one LED is illuminated to be compensated for appropriately such that all the LEDs appear to be equally bright.

The resulting appearance of display system where the duty cycles are calculated for the virtual groups can be seen in FIG. 10b. In contrast to FIG. 10a, all of the LEDs appear to be equally bright. This allows for different patterns of LEDs to be displayed by illuminating different numbers of LEDs. Every time the pattern is changed, a new compensation factor is used by changing the duty cycles according to the number of LEDs in the virtual groups. These compensation factors may be calculated design and testing of the display system and stored in the memory 9 in the form of a lookup table. The processor then simply needs to select the appropriate compensation factor for the number of LEDs being illuminated at any moment.

In embodiments in which RGB LEDs are driven the Applicant has observed that the hue of the RGB LEDs is not affected significantly by their intensity and thus the invention is equally applicable to RGB LEDs.

1. A method of operating a display system comprising a plurality of light emitting diodes (LEDs) arranged in a plurality of groups and an integrated circuit providing power to the LEDs through a plurality of output pins connected to respective groups, the method comprising:
the integrated circuit selectively determining the states of the output pins to illuminate the groups of LEDs in a repeating sequence such that each group is illuminated for a time dependent on a number of groups and a compensation factor, wherein the compensation factor is dependent on at least a number of LEDs in the group.

2. The method of operating a display system as claimed in claim 1, wherein each group of LEDs comprises a different number of LEDs.

3. (canceled)

4. The method of operating a display system as claimed in claim 1, wherein the output pins occupy one of three different states: high; low; off, wherein ‘high’ is a high voltage, ‘low’ is a low voltage and ‘off’ is a high impedance state.

5. The method of operating a display system as claimed in claim 4, comprising determining the states of the output pins such that each group of LEDs is illuminated individually.

6. (canceled)

7. The method of operating a display system as claimed in claim 1, wherein the LEDs are electrically paired in anti-parallel such that the paired LEDs have opposite terminals connected to the same output pin.

8. The method of operating a display system as claimed in claim 1, wherein the compensation factor depends on an empirically determined performance curve of the output pins.

9. The method of operating a display system as claimed in claim 1, wherein the compensation factor accounts for a relationship between applied voltage and brightness of the LEDs.

10. The method of operating a display system as claimed in claim 1, comprising retrieving compensation factor values for each of the plurality of groups from a memory.

11. The method of operating a display system as claimed in claim 1, wherein at least one of said plurality of groups comprises a virtual group of LEDs which is a subset of a physical group of LEDs and the method comprises illuminating said virtual group of LEDs whilst a remainder of the physical group of LEDs remain unilluminated.

12. The method as claimed in claim 11, comprising selecting said compensation factor based on a number of LEDs in the virtual group.

13. A system comprising:
a display system comprising a plurality of light emitting diodes (LEDs), wherein the LEDs are arranged in a plurality of groups;
a plurality of output pins connected to the plurality of groups of LEDs; and
an integrated circuit arranged to provide power to the LEDs through the plurality of output pins,
wherein the integrated circuit is arranged to selectively determine the states of the output pins to illuminate the groups of LEDs in a repeating sequence such that each group is illuminates for a time dependent on a number of groups and a compensation factor, wherein the compensation factor is dependent on at least a number of LEDs in the group.

14. The system as claimed in claim 13, wherein each group of LEDs comprises a different number of LEDs.

15. (canceled)

16. The system as claimed in claim 13, wherein the output pins are arranged to occupy one of three different states: high; low; off, wherein ‘high’ is a high voltage, ‘low’ is a low voltage and ‘off’ is a high impedance state.

17. The system as claimed in claim 16, wherein the integrated circuit is arranged to determine the states of the output pins such that each group of LEDs is illuminated individually.

18-19. (canceled)

20. The system as claimed in claim 13, wherein the compensation factor depends on an empirically determined performance curve of the output pins.

21. The system as claimed in claim 13, wherein the compensation factor accounts for a relationship between applied voltage and brightness of the LEDs.

22. The system as claimed in claim 13, wherein the integrated circuit comprises a memory arranged to store compensation factor values for each of the plurality of groups.

23. The system as claimed in claim 13, wherein at least one of said plurality of groups comprises a virtual group of LEDs which is a subset of a physical group of LEDs and the integrated circuit is arranged to illuminate said virtual group of LEDs whilst a remainder of the physical group of LEDs remain unilluminated.

24. The system as claimed in claim 23, wherein the integrated circuit is arranged to select said compensation factor based on a number of LEDs in the virtual group.

25. (canceled)

26. An electronic device comprising:
a plurality of output pins arranged to connect to a plurality of groups of light emitting diodes (LEDs); and
an integrated circuit arranged to provide power to the LEDs through the plurality of output pins,
wherein the integrated circuit is arranged to selectively determine the states of the output pins to illuminate the groups of LEDs in a repeating sequence such that each group is illuminated for a time dependent on a number of groups and a compensation factor, wherein the compensation factor is dependent on at least a number of LEDs in the group.
